(19) United States
(12) Patent Application Publication
(10) Pub. No.: US 2009/0242644 A1
(43) Pub. Date: Oct. 1, 2009

(54) Method and System for Limiting Peak Power Consumption in an Imaging Bar Code Scanner

(76) Inventor: Dariusz MADEJ, Shoreham, NY (US)

Correspondence Address: MOTOROLA, INC., 1303 EAST ALGONQUIN ROAD, IL01/3RD, SCHAUMBURG, IL, 60196, US

(21) Appl. No.: 12/055,426

(22) Filed: Mar. 26, 2008

(51) Int. Cl. G06K 7/10

(52) U.S. Cl. 235/462.41

(57) ABSTRACT

A system includes a processor; an imager; and an illumination arrangement. When an image capture process is initiated, the imager and illumination arrangement are powered on and the processor is switched to a low power state.

### BACKGROUND

Imaging bar code scanners use increasingly powerful processors to improve image processing performance. Such scanners may also use powerful illumination means such as LEDs to improve image capture performance. The combination of the powerful processor and the powerful illumination results in a very high consumption of power.

### SUMMARY OF THE INVENTION

The present invention relates to a system includes a processor; an imager; and an illumination arrangement. When an image capture process is initiated, the imager and illumination arrangement are powered on and the processor is switched to a low power state.

### BRIEF DESCRIPTION OF THE DRAWINGS

FIG. 1 shows a schematic diagram of an exemplary image scanner according to the present invention.

FIG. 2 shows an exemplary method for minimizing the peak power consumption of an image scanner according to the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe methods and systems for minimizing peak power consumption by imaging bar code scanners.

Newer generations of imaging bar code scanners may typically use increasingly powerful processors. When these processors are clocked at full speed (e.g., several hundred MHz), they may consume substantial amounts of electric power. Some imaging applications (e.g., decoding bar codes in a swipe mode to capture the image of a moving label with a minimal distortion) require the use of a short acquisition time, and thus a very high external illumination level. The need for very bright illumination elements (e.g., LEDs) may also lead to increasing power requirements. These two components may be the largest contributors to the total power consumption of the device.

The high combined power requirements of processors and illumination elements may lead to situations wherein the total peak power consumption (e.g., when images of a bar code are being collected) may exceed the capabilities of an attendant power supply mechanism (e.g., a USB connection), though the supplied power is adequate to supply the average required power. The exemplary embodiments of the present invention address this deficiency by reducing power requirements at times of peak power consumption. While the exemplary embodiments relate specifically to imaging scanners including illumination elements that draw a significant amount of power, those of skill in the art will understand that the broader principles of the present invention may also apply to other devices for which it may be desirable to limit peak power consumption.

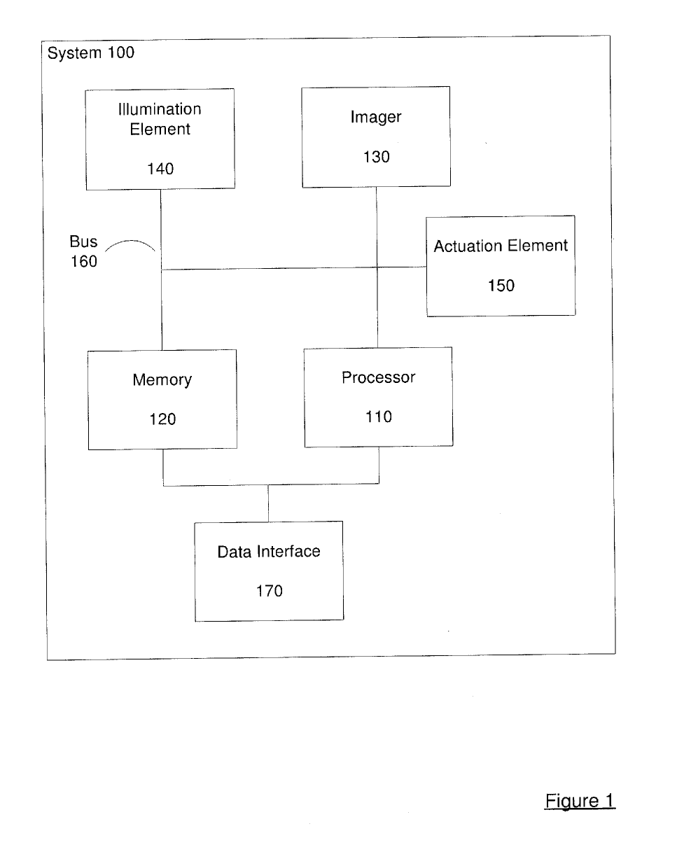

FIG. 1 illustrates an exemplary system 100 according to the present invention. The system 100 may include a processor 110, which may be any processor capable of executing instructions embodied in code. Depending on the specific configuration of the system 100 and the processor 110, the processor 110 may be capable of adjusting its clock rate, switching off some of its internal components, or otherwise adjusting its own performance to meet requirements. The system 100 may also include a memory 120 that may be coupled to the processor 110 to enable it to execute instructions. The memory 120 may include short-term memory (e.g., RAM), long-term memory (e.g., a magnetic storage drive), or a combination of the two.

To enable scanning, the system 100 may include an imager 130, which may be any image capture mechanism suitable for the needs of a user of the system 100. To aid the performance of the imager 130, the system 130 may further include an illumination element 140, such as LEDs, as discussed above. The imager 130 and the illumination element 140 may be engaged by the user by an actuation element 150, which may be a button, a trigger, a sensor, etc. However, those skilled in the art will understand that an actuation element 150 is not required. The components of the system 100 may communicate with one another by means of a bus 160. The processor 110 and the memory 120 may communicate with external resources (e.g., export processed image data, etc.) by way of a data interface 170. In some embodiments of the present invention, the data interface 170 may be a USB connection; in such embodiments, the data interface 170 may serve both to export data from the system 100 and to provide power to the system 100.

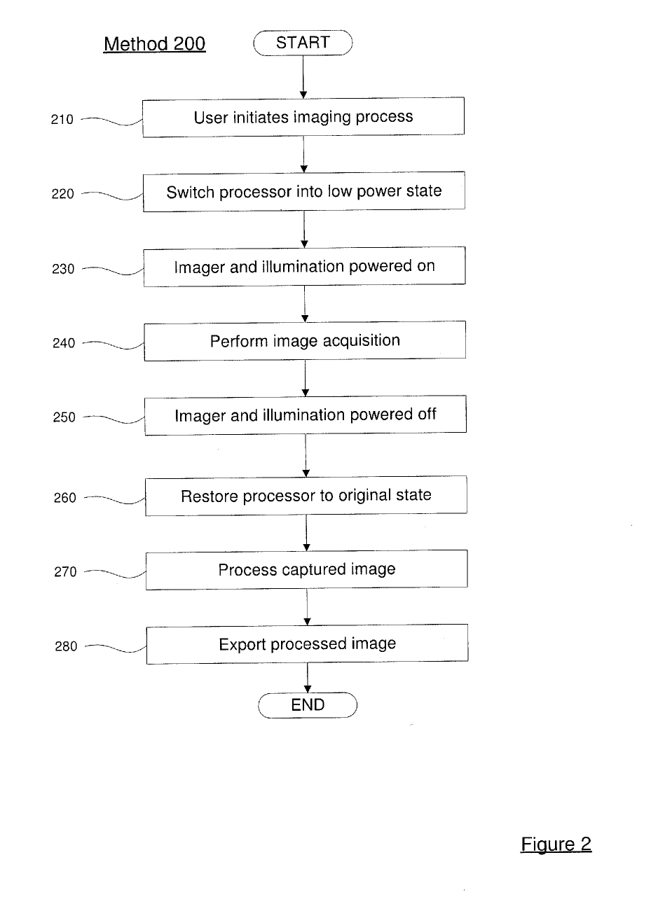

FIG. 2 illustrates an exemplary method 200 by which the system 100 may operate. While the method 200 will be described specifically with reference to the system 100, those of skill in the art will understand that the steps of the exemplary method 200 may also be applied by systems that differ from the exemplary system 100. Prior to the execution of the method 200, the system 100 may be powered on, with the processor 110 operating using its full capacity, while the imager 130 and the illumination element 140 is powered off. In step 210, a user of the system 100 begins the imaging process by engaging the actuation element 150.

In step 220, the processor 110 is switched into a low power consumption state. Various embodiments of the present invention may accomplish this low power consumption state in various ways. In one example, the clock rate of the processor 110 may be reduced. This reduction may be to the minimum speed for which the direct memory access (“DMA”) channel used for image transfer may function properly. For such an embodiment, the image (or sequence of images) acquired may be stored in the memory 120 to be processed after the imager 130 and/or illumination element 140 are powered off.

In another example of the low power consumption state initiated in step 220, one or more internal components of the processor 110 may be temporarily switched off while others remain active. For example, a computing core of the processor 110 (which may consume the most power of any component of the CPU) may be temporarily suspended while DMA function and the memory 120 remain active. In another example of the low power consumption state, if the imager 140 is able to store an image that it is exposed to, the processor 110 may be shut off entirely, with DMA function delayed while the low power state remains in effect.

In another exemplary embodiment, the system 100 may include a second processor (not shown) that shares access to the memory 120. This second processor may require less power than the processor 110; in such an embodiment, the low power consumption state initiated in step 220 may involve powering down the processor 110 while the second processor enables DMA function and controls image acquisition. In addition to the various changes to the state of the processor 110 that may occur in step 220, other components of the system 100, not shown in FIG. 1 (e.g., data interfaces, other external interfaces, radio components, etc.) may also be temporarily powered down.

In step 230, the imager 130 and the illumination element 140 are powered on to enable image capture. Step 230 may occur as soon as possible after step 220; those of skill in the art will understand that while it may be desirable for these steps to occur substantially simultaneously, practicalities of product design or programming may necessitate some delay between these steps. Depending on the precise nature of the power reduction of step 220 (e.g., if the processor 110 is completely powered down), the system 100 may need to include an additional component to act as a delay switch (e.g., a multivibrator) that may engage the image capture process of step 230 shortly after step 220 is completed.

In step 240, the imager 140 performs image acquisition; image data may typically be stored to the memory 120. This step may proceed substantially similarly to image acquisition processes that are well known in the art. In step 250, the imager 140 and/or the illumination element 150 are disengaged; this may occur when the user disengages the actuation element 160, after a predetermined time period, or as a response to some other criterion.

After the imager 140 and/or the illumination element 150 are disengaged, in step 260 the processor 110 is returned to its original state (e.g., the changes that occurred in step 220 are reversed). Similar to the above, this may involve increasing the clock rate of the processor 110, powering up internal components of the processor 110 that may have been powered down, powering up the processor 110 if it was powered down, etc. In step 270, the processor 110 processes the image that was captured in step 240; this image processing step may proceed substantially according to methods that are well known in the art. Finally, in step 280, the system 100 may export the processed image or data corresponding to the image via the data interface 170.

In another exemplary embodiment of the present invention, the system may incorporate a power management task (e.g., as software executed by the processor 110 or as an ASIC running separately from the processor) that may control the low power state according to the level of illumination required. For example, when power consumption by the illumination element 150 is low, the adjustments made to the processor 110 (or to other components of the system 100) may be less significant. This may be implemented, for example, by monitoring the level of ambient light and configuring the illumination element 150 to provide a level of illumination appropriate to the level of ambient light. Based on the desired level of illumination, the power management task may determine which components should be powered off or the level of powering down of components such as the processor 110.

The exemplary embodiments of the present invention may enable imaging scanners to incorporate illumination elements that provide a high level of illumination, without reducing the processing power of the scanner. This may be particularly important for scanners that, as described above, draw their power from a source such as a USB connection that has limited capacity for power delivery. The exemplary embodiments of the present invention may be adapted to provide for different adjustments in processor power usage depending on the requirements of a particular illumination system, processor, imager, power supply means, etc.

Those skilled in the art will understand that the above-described exemplary embodiments may be implemented in any number of manners, including as a separate software module, as a combination of hardware and software, etc. For example, the processor 110 may execute a program controlling the operation of the system and containing lines of code that, when compiled, may be executed by the processor.

It will be apparent to those skilled in the art that various modifications may be made in the present invention, without departing from the spirit or the scope of the invention. It will further be apparent that while the exemplary embodiments have been described specifically with reference to imaging bar code scanners, the same principles may also be applicable to other devices for which it may be desirable to limit peak power consumption. Thus, it is intended that the present invention cover modifications and variations of this invention provided they come within the scope of the appended claims and their equivalents.

What is claimed is:

1. A method, comprising:
initiating an image acquisition process; and
setting a processor to a low power state while the image acquisition process is active.

2. The method of claim 1, wherein the processor is set to the low power state by reducing a clock rate of the processor.

3. The method of claim 1, wherein the processor is set to the low power state by powering down an internal component of the processor.

4. The method of claim 3, wherein the internal component is a computing core.

5. The method of claim 1, wherein the processor is set to the low power state by powering off the processor.

6. The method of claim 5, wherein a further processor is active while the processor is powered off.

7. The method of claim 1, further comprising:
acquiring an image;
terminating the image acquisition process; and
removing the processor from the low power state after the image acquisition process terminates.

8. The method of claim 7, further comprising:
processing the image; and
exporting the processed image.

9. The method of claim 7, wherein the image is a bar code.

10. The method of claim 1, further comprising engaging an illumination element while the image acquisition process is active.

11. A system, comprising:
a processor;
an imager; and
an illumination arrangement,
wherein, when an image capture process is initiated, the imager and illumination arrangement are powered on and the processor is switched to a low power state.

12. The system of claim 11, wherein the processor is set to the low power state by reducing a clock rate of the processor.

13. The system of claim 11, wherein the processor is set to the low power state by powering down an internal component of the processor.

14. The system of claim 13, wherein the internal component is a computing core.

15. The system of claim 11, wherein the processor is set to the low power state by powering off the processor.

16. The system of claim 15, wherein a further processor is active while the processor is powered off.

17. The system of claim 16, wherein the imager holds image data while the processor is powered off.

18. The system of claim 11, wherein the processor is switched out of the low power state when the image capture process terminates.

19. The system of claim 11, wherein a parameter of the low power state is a function of a level of ambient light.

20. The system of claim 11, further comprising:
a further component that is powered off while the processor is in the low power state.

21. A computer readable storage medium including a set of instructions executable by a processor, the instructions operable to:
receive an instruction to initiate an image capture process;
initiate the image capture process; and
place the processor in a low power state while the image capture process is active.
